(19) United States
(12) Patent Application Publication
(10) Pub. No.: US 2011/0052428 A1
(43) Pub. Date: Mar. 3, 2011

(54) ELECTRIC FUEL PUMP FOR HEAVY DUTY ENGINE PLATFORMS

(75) Inventor: Mehmet Feyyaz Tarancioglu, Izmir (TR)

(73) Assignee: SUPERPAR OTOMOTIV SANAYI VE TICARET ANONIM SIRKETI, Izmir (TR) (TR)

(21) Appl. No.: 12/863,300

(22) PCT Filed: Jan. 16, 2008
(86) PCT No.: PCT/TR2008/000004

§ 371 Date: Jul. 16, 2010

(51) Int. Cl. F02M 37/08; F04D 29/58

(52) U.S. Cl. 417/366

(57) ABSTRACT

This invention relates to a Brushless DC Electric Fuel Pump (BEFP) for an internal combustion engine having a cooling system which transfers all the heat generated by its components to the heat conducting body parts and carrying the heat away not only by the fuel but also air by the use of sealed fuel channels and external heat sinks. The Brushless DC Electric Fuel Pump has a main housing, a stator within the housing, an inlet cover which fuel is drawn into, an intermediate cover and a pump body.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to an electric fuel pump capable of supplying fuel for internal combustion engines up to and including Tier 5 compatible Heavy Duty Engine Platforms (HDEP).

The invention relates particularly to a Brushless DC Electric Fuel Pump (BEFP) powerful enough to meet the fuel and pressure requirements of HDEP class engines and eliminate the disadvantages of currently used engine driven gear fuel pumps.

2. Description of Related Art Including Information Disclosed Under 37 CFR 1.97 And 37 CFR 1.98.

As emission standards are getting more and more stringent throughout the whole world, engine manufacturers are under pressure to meet the emission regulations for the areas of the world they are selling their engines. Emission regulations are imperative and are scheduled to be effective on different dates, basically earlier for the richer parts of the world and later for the poorer parts depending on their economical strength to support the change.

HDEP, as the name implies, points to a generation of engines capable of pushing truck fleets across countries and continents almost with no engine shutdown. Each of these trucks hide beneath their driver cabins, massive power plants capable of developing 500-600 horsepower, which is barely enough to push payloads of 50-60 tons up the hills.

Engine manufacturers have been using engine driven gear pumps ever since, but unfortunately, as the gear pumps are dependant only on the engine speed, they do not feed the engine with the precise amount of fuel required for the actual load and speed conditions leading to poor or rich air/fuel mixtures and causing release of high levels of NOX and particle emissions. There is a need to build a fuel pump which is capable of feeding these monster engines with exactly the amount of fuel based on their appetite from a few hundred mL/min at low idle up to 10 L/min at full load. The requirement is definitely beyond the capability of an engine driven gear pump.

Several BFEP patents which have been issued to inventors are cited here. A person skilled in the art can find more. For example; the patent application no U.S. Pat. No. 6,296,458 B1 relates to electric fuel pumps for internal combustion engines and an object of this invention is to provide means by which an electric fuel pump having a motor with electronic commutation can be operated and manufactured without problems. There can be found some related patent documents in patent literature and databases. Another patent application concerning BFEP is U.S. Pat. No. 4,998,865 numbered patent application and it discloses a motor-driven pump having a brushless motor for pumping liquid. And its first object is to provide a motor-driven pump which may improve the sensitivity of the position detecting device for detecting a rotor position of the motor.

Today, to increase efficiency of the fuel pumps on vehicles, various electric fuel pumps have been manufactured. Electric fuel pumps for internal combustion engines have long been known and used around the world. Regarding internal combustion engines, there have been many applications at present, one of these applications is U.S. Pat. No. 5,120,201 A1 numbered patent application and it relates fuel delivery systems for internal combustion engines, and more particularly to a self-contained electric-motor fuel pump for use therein.

When the prior art, drawings, descriptions and claims of each of these patents are reviewed, it will be obvious to a person skilled in the art that all of the BEFP inventions have targeted small power automotive applications which use the fuel as the cooling media. None of them point to high power applications for the heavy transport industry where the amount of heat that must be removed from the fuel pump is in the order of 40-50 watts, which is equivalent to placing a heater in the fuel tank. This situation is unacceptable to engine manufacturers who like warm fuel in winter but hate hot fuel in summer. These fuel pumps must operate fulltime.

As a result, the presence of the need to replace the engine driven gear fuel pump with an independent fuel pump whose pressure and flow can be controlled precisely according to the engine's requirement has made it necessary to perform an improvement in the relevant technical field.

The few currently manufactured tiny BEFP units are unable to meet the requirements of the HDEP field because they depend only on the incoming fuel to cool their electronics and windings.

The basic idea behind the present invention is to replace the gear pump with a BEFP, which is powerful enough, which can be controlled precisely to meet Tier 5 regulations and does not only use the incoming fuel to cool its heated parts but also air so that it can be used in all climates from the poles to the equator. Tier 5 regulations are made to standardize emission values and these standards specifically restrict emissions of carbon monoxide (CO), oxides of nitrogen (NOx), particulate matter (PM), formaldehyde (HCHO), and non-methane organic gases (NMOG) or non-methane hydrocarbons (NMHC). The limits are defined in the mixed-system unit of grams per mile (g/mi).

### BRIEF SUMMARY OF THE INVENTION

The present invention relates to a solution that will replace the engine driven gear fuel pumps used on HDEP engines and fill the gap between the prior art and the tiny BEFP units which are unable to meet the technical demand.

Based on the state of the background art, the main object of this invention is to replace the engine driven gear fuel pump with a BEFP.

Another object of this invention is to replace the engine driven gear pump with a BEFP whose pressure and flow can be tailored precisely according to the engine load conditions and make it Tier 5 compliant.

Yet another object of this invention is to replace the engine driven gear pump with a BEFP which does not cause heat related problems in the fuel system in all climates.

Yet another object of this invention is to replace the engine driven gear pump with a unit which draws about 200-250 watts from the battery rather than from the engine. This contributes to the improvement of the overall engine fuel consumption which turns out to be several hundred USD when annual mileages of HDEP engine mounted trucks are considered. A further improvement to overall emissions is obtained because the BEFP is powered from the battery.

Yet another object of this invention is to replace the engine driven gear pump with an independent fuel pump leading to simpler engine block configuration where there are no machined openings, gears or belts that need maintenance are required.

Yet another object of this invention is to replace the engine driven gear pump with an independent unit that requires no maintenance over the whole life of the engine.

Yet another object of this invention is to replace the engine driven gear pump with a technologically superior unit which is slightly more expensive but which pays for itself and environment in a very short term.

The structural and characteristic features and all the advantages of the invention will become more clear from the enclosed drawings and the following detailed description where reference is being made to said drawings, thus the evaluation must be based on these drawings and the detailed description.

### BRIEF DESCRIPTION OF THE DRAWINGS

In order to best understand the embodiment of the present invention and the advantages thereof together with the supplemental elements, it must be considered along with the drawings for which the description is provided below.

FIG. 1 is an exploded view of the fuel pump revealing the fuel flow path and heat exchange surfaces.

FIG. 2 is a schematic view of the complex heat transfer system.

### DETAILED DESCRIPTION OF THE INVENTION

In the following detailed description, the method and mechanism of introducing a BEFP which can replace an engine driven gear pump is explained only to enable better understanding of the subject, without any restricting effect.

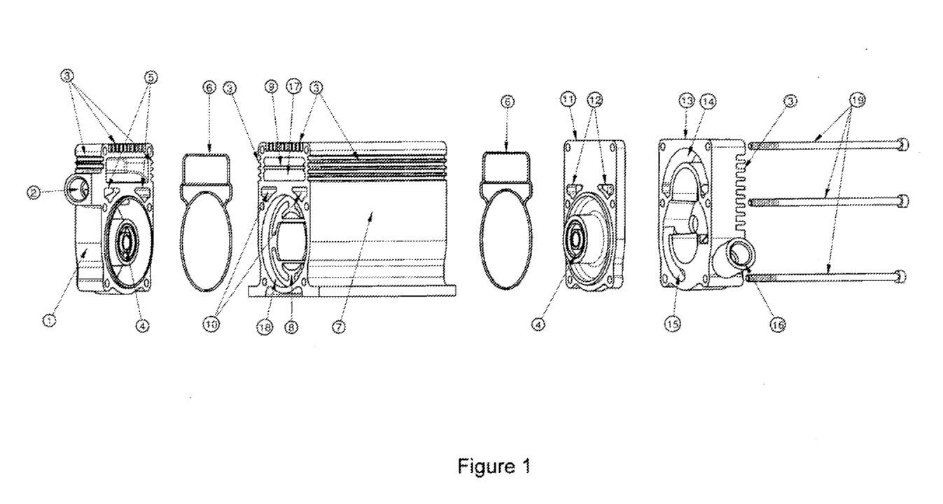

A first preferred embodiment of the fuel pump according to the present invention referring now in detail to the drawings and initially FIG. 1. In the exploded view of the fuel pump showing only the critical components of the heat transfer path in FIG. 1, there is a fuel inlet cover (1), a fuel inlet port (2), heat sinks (3), bearings (4), fuel inlet connections (5), multi-eye o-rings (6), main housing (7), stator (8), electronic subassembly (9), fuel channels (10), intermediate cover (11), connecting channels (12) which are connecting main housing channels (10) to pump inlet chamber (14), pump body (13), pump inlet chamber (14), pump outlet chamber (15), fuel outlet port (16), electronic subassembly compartment (17) and stator compartment (18).

Fuel is drawn into the inlet cover (1) through inlet port (2). Fuel flow is divided into a plurality of fuel inlet connections (5) which are sealedly connected by multi-eye o-ring (6) to a mating plurality of fuel channels (10) in housing (7). Fuel channels (10) are integral part of the housing (7) and are heat conductibly connected to the rest of the aluminum housing (7). Also heat conductibly connected to the housing (7) are the stator (8) and electronic subassembly (9). The heat sinks of the power transistors of the electronic subassembly (9) are heat conductibly connected to the housing (7) and benefit from cooling by the fuel flow and air.

In this invention the aluminum pump body is so cleverly used as a cooling administration servo valve which collects all the heat generated in the individual components, averages them in its mass and dissipates the heat to fuel and air whichever is available.

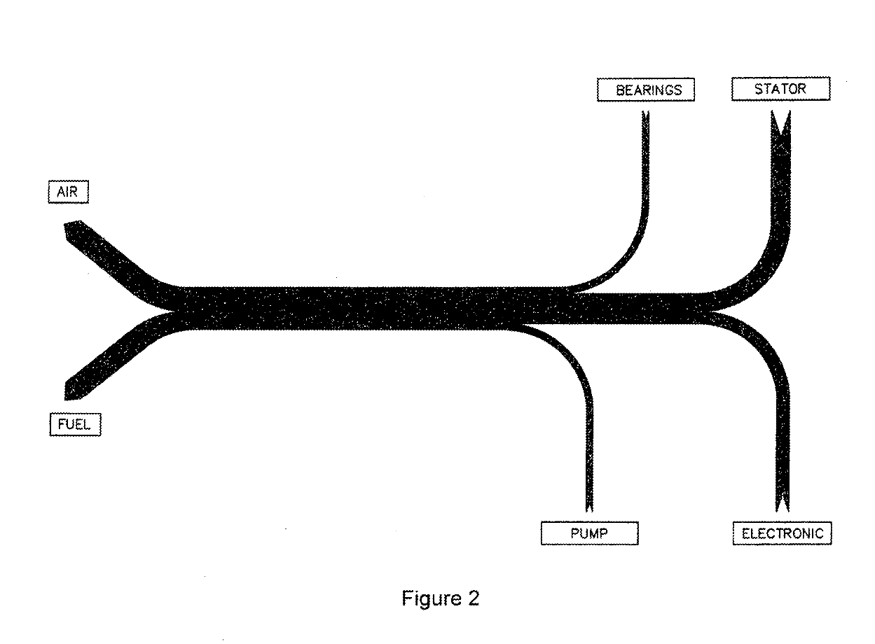

FIG. 2 shows very clearly the heat flow in the housing. Heat generated in individual components is transferred to the housing through conduction, averaged in the housing by the clever geometry of the housing and dissipated in a balanced way by fuel flow and air depending on the ambient conditions.

In a preferred subassembly of this invention the main housing (7), the positioning of the stator (8), fuel channels (10), electronic subassembly compartment (17) and heat sinks (3) are in close relation to each other. The fuel channels (10) and the heat sinks (3) are positioned very cleverly where heat generation and removal is most critical.

In another preferred subassembly of this invention the multi-eye o-rings (6) seal all internal compartments from external disturbances but also form the sealed fuel passage from the inlet port (2) to the pump inlet chamber (14) via fuel channels (10) and connecting channels (12) thereby protecting the stator (8), bearings and electronic subassembly from corrosion or chemical attack by the fuel.

The protective scope of this application is determined in the section of claims and the scope may by no means be limited to the description above provided only for exemplary purposes. It is obvious that a person skilled in the art may provide the innovation put forward by the invention also by using the similar embodiments and/or apply this embodiment to other fields with similar purpose used in the relevant art. Consequently, such embodiments would obviously lack the criteria of innovative step in exceeding the known state of the art.

1. A Brushless DC Electric Fuel Pump (BEFP) for an internal combustion engine having a cooling system which transfers all the heat generated by its components to the heat conducting body parts and carrying the heat away not only by the fuel but also air by the use of sealed fuel channels and external heat sinks, comprising; a main housing, a stator within the housing, an inlet cover which fuel is drawn into, an intermediate cover and a pump body.

2. A Brushless DC Electric Fuel Pump (BEFP) for an internal combustion engine as claimed in claim 1, said inlet cover comprising one inlet port and a plurality of fuel inlet connections, said inlet port being internally connected to said fuel inlet connections.

3. A Brushless DC Electric Fuel Pump (BEFP) for an internal combustion engine as claimed in claim 1, said inlet cover comprising a plurality of heat sinks and at least one bearing.

4. A Brushless DC Electric Fuel Pump (BEFP) for an internal combustion engine as claimed in claim 1, said main housing comprising one stator compartment, a plurality of fuel channels, an electronic subassembly compartment and a plurality of heat sinks.

5. A Brushless DC Electric Fuel Pump (BEFP) for an internal combustion engine as claimed in claim 1, said main housing being stacked with said inlet cover from one side and intermediate cover from the other side by a plurality of bolts forming a plurality of sealed compartments by use of a plurality of multi-eye o-rings, said o-rings at the same time sealing said compartments from external disturbances.

6. A Brushless DC Electric Fuel Pump (BEFP) for an internal combustion engine as claimed in claim 1, comprising a multi-eye o-ring having a plurality of eyes, one of said eyes sealing the electronic subassembly compartment, a plurality of eyes sealing the fuel flow channels and one of said eyes sealing the stator compartment, said multi-eye o-ring protecting a plurality of dry compartments from internal fuel leaks and external disturbances

7. A Brushless DC Electric Fuel Pump (BEFP) for an internal combustion engine as claimed in claim 1, comprising an intermediate cover having a plurality of connecting channels, which sealedly connect the fuel channels to pump inlet chamber by use of multi-eye o-ring and housing at least one bearing.

8. A Brushless DC Electric Fuel Pump (BEFP) for an internal combustion engine as claimed in claim 1, comprising a pump body having a plurality of heat sinks, said heat sinks contributing to the heat removal from the pump itself and other body parts in heat conductive contact with said pump body.

9. A Brushless DC Electric Fuel Pump (BEFP) for an internal combustion engine as claimed in claim 1, said inlet cover, said housing, said intermediate cover and said pump body parts being manufactured from a good to excellent heat conducting material.
